(19) United States
(12) Patent Application Publication
(10) Pub. No.: US 2013/0059037 A1
(43) Pub. Date: Mar. 7, 2013

(54) METHOD FOR CONTROLLING PRODUCT CHARACTERISTICS IN THE PRODUCTION OF FOODSTUFFS

(71) Applicants: Volker Heinz, Quakenbruck (DE); Fritz Kortschack, Berlin (DE); Stefan Töpfl, Osnabruck (DE); Christian Hertel, Quakenbruck (DE)

(72) Inventors: Volker Heinz, Quakenbruck (DE); Fritz Kortschack, Berlin (DE); Stefan Töpfl, Osnabruck (DE); Christian Hertel, Quakenbruck (DE)

(73) Assignees: Deutsches Institut fur Lebensmitteltechnik e.V., Quakenbruck (DE); Triton GmbH, Berlin (DE)

(21) Appl. No.: 13/261,416

(22) PCT Filed: Feb. 11, 2011
(86) PCT No.: PCT/EP11/52014

§ 371 Date: Nov. 20, 2012

(30) Foreign Application Priority Data
Mar. 4, 2010 (DE) 102010010118.4

(51) Int. Cl. A23L 1/317

(52) U.S. Cl. 426/58; 426/59

(57) ABSTRACT

The invention relates to a method for controlling the product features during the production of foodstuffs attributable to the product groups raw sausage and cooked sausage, pies, cooked meat products or similar products, in particular to obtain spreading properties or cutting properties. According to the invention, for the production of raw sausage the usual starting materials are salted, mixed and coarsely pre-chopped, not in a deep-frozen state, however. This mixture is subjected to fermentation and acidification, followed by a high-pressure treatment for the coagulation of protein, which simultaneously leads to an inactivation of microorganisms, with the mechanically separated raw meat materials remaining separated. This is followed by a fine comminution and filling. Similarly, for the production of cooked sausage usual starting materials are used, but are processed in the non-heated state, i.e. initially salted, mixed and coarsely pre-chopped. This mixture is subjected to a high-pressure treatment in order to predefine the later consistency of the end product by means of the pressure intensity and the treatment time and the resulting degree of protein denaturation, wherein the recipe mixture comminuted to the final grain size subsequently is filled into a sales wrapping and subjected to a second high-pressure treatment, so that altogether fat separations in the product are prevented and the spreadability of the product over a longer period is preserved. Surprisingly, the high-pressure treatment intensifies the perception of sensorially activated substances, so that the salt content in the product can be reduced in a health-promoting manner.

The invention relates to a method for controlling the product features during the production of foodstuffs attributable to the product groups raw sausage and cooked sausage, pies, cooked meat products or similar products, in particular to obtain spreading properties or cutting properties, as supplement to Patent DE 10 2008 048 543.

EP 0 944 329 B1 and DE 196 53 677 C1 describe a method for the production of stable meat and sausage products which are produced in the presence of microorganisms.

The object of the teaching of these documents is to provide a method according to which production steps for the production of raw and durable sausage can be carried out in a simple and reliable manner, and by means of which a qualitatively stable end product is obtained.

It is the object of the prior method to subject semi-finished products, after a desired final pH-value was obtained, for some minutes to a high-pressure treatment at room temperature in order to hold this final pH-value, and to continue with the processing thereof in the usual manner. The high-pressure treatment aims at deliberately interrupting the activities of the microflora in the semi-finished product. Thus, no more relevant biochemical processes take place.

The European patent application EP 0 668 026 A1 discloses a formulation for producing low salt and/or low phosphate sausages to minimize salts and phosphates used to bind water. The method described requires that the needed amount is treated with pressure at 500 bar to 4000 bar, and is thermally treated afterwards. It is the aim of this treatment to optimize the formulation.

The prior art further discloses methods for the treatment of foodstuffs, in particular for the preservation of fresh sausage products and meat products, by means of temperatures and/or pressure or high pressure which act on the products for a limited time, as well as for placing these products on the market subsequently. According to DE 10 2005 011 868 A1, for example, the product is packaged and then subjected to the treatment step. At least parts of the packaging material are made of a film which is expandable or has a residual or permanent elasticity.

The main feature of the technology used for the production of cooked sausage is that the production, in particular of blood sausage varieties, has to be carried out at temperatures as high as possible. Diced meat material and/or bacon material used, too, has to be scalded at boiling temperature and is processed at temperatures as high as possible. Also, it is of prime importance that the sausages are cooked without any temperature drop throughout the cooking time. Cooling, e.g. by adding cold water, also in cases where the temperature is too high, has a shock-like effect on the core temperature in particular of blood sausages, and results in a soft core with a red coloring of the bacon bits in the finished product.

In the production of raw sausages a difference is made between firm and spreadable raw sausage products. These production methods require even more differentiations as, for example, also the granularity both in firm and spreadable raw sausages requires a specific technology. In principle, the meat material used for firm raw sausages has to be deep-frozen prior to the actual sausage production. The further treatment of the meat material prior to the actual raw sausage production then includes chopping the deep-frozen meat blocks. Depending on the size of the meat cutter the frozen pieces must approximately have the size of a fist, allowing the cutter blades to pick up and chop the frozen material.

The meat and bacon material used for the production of spreadable raw sausage products should likewise only be processed in a well-cooled state. In the hotter season it is even recommendable to slightly deep-freeze the material. At any rate, it must be ensured that the meat does not already become greasy in the mincing machine as it may be squeezed rather than cut.

It can be learned from the foregoing that the production of raw sausage and cooked sausage requires very complicated technological steps, which cannot be unified without further ado to obtain different types of sausage.

Therefore, it is the object of the invention to provide a further developed method for controlling the product features during the production of foodstuffs attributable to the product groups raw sausage and cooked sausage, pies, cooked meat products or similar products, in particular to obtain spreading properties or cutting properties, which guarantees a very high level of food safety and long lasting good qualities. Moreover, the tenderness of the products is to be upgraded, and the tolerance is to be enhanced.

The solution to the object of the invention is achieved by a method according to the teaching of patent claim 1 and by a method according to the teaching of patent claim 4. The dependent claims define at least useful embodiments and improvements.

The method for controlling the product features during the production of raw sausage is, therefore, based on the use of usual starting materials. However, these starting materials are salted, mixed and coarsely chopped at room temperature, and not in a deep-frozen state. This mixture is then subjected to fermentation and acidification, i.e. to a specific pH-value reduction.

According to the invention either a fine comminution is carried out after the protein denaturation or, alternatively, a high-pressure treatment for the coagulation of the protein and inactivation of microorganisms, with the mechanically separated raw meat materials remaining separated. Furthermore, if necessary, these treatment steps are followed by a fine comminution.

For the production of cooked sausage, too, usual starting materials are salted, mixed and coarsely pre-chopped, but not in a heated state.

This mixture is then subjected to a high-pressure treatment in order to predefine the later consistency of the end product by means of the pressure intensity and the treatment time and the resulting degree of protein denaturation.

After this treatment step the recipe mixture is comminuted to the final grain size and filled into a sales wrapping or packaging. This may be followed by a second high-pressure treatment, so that altogether fat separations in the product are prevented and the spreadability of the product is preserved.

According to an embodiment the production of raw sausage may include subjecting the filled product to another, second high-pressure treatment.

Again, it is possible in this connection to realize the addition of fat during the comminution to the final grain size, followed by the second high-pressure treatment.

The production of cooked sausage may also involve the filling of the product into a water-permeable casing or corresponding envelope. Even with such a filling material constellation the product remains spreadable for a longer time than was the case to date with the known drying technique.

In the production of cooked meat products, such as boiled ham, marinated meat products, smoked pork chops or similar products, these products are subjected to a high-pressure treatment after the curing, either in whole, in pieces or slices.

The high-pressure treatment causes a protein coagulation, which makes the contained water remain in the product longer, even in a heated state, with the result that the product volume is clearly increased in comparison with known production methods. Also, it can be observed that the respective foodstuff has become more tender by the pressure treatment.

It has shown in a surprising manner that a supplementary high-pressure treatment, and also a high-pressure treatment combined with the above-mentioned method steps of the semi-finished product, the finished product, or of raw materials or taste-relevant additives, are of considerable advantage for the intensified perception of sensorially activated substances.

According to the invention the intensified perception of added salt allows a reduction of the salt content as a whole, which results in a better and health-promoting tolerance of the end product.

The invention will be explained in more detail below by means of exemplary embodiments.

As was already explained above, the basic idea of the invention is the long-term preservation of the spreadability of the finished product by a special high-pressure treatment of the raw material or raw material mixture still to be comminuted to the final grain size.

In the production of spreadable raw sausage the raw material is coarsely pre-chopped and mixed with salt and spices as well as possible starter cultures.

This is followed by the desired reddening, acidification and fermentation at temperatures suited therefor, e.g. about 18° C., over a period of about 24 hours.

This matured, fermented mixture is then subjected to a high-pressure treatment, with possible pressure ranges of up to 6000 bar and more, and an exposure time of substantially 3 minutes. This high-pressure treatment then results in the desired protein coagulation.

After the high-pressure treatment was carried out, the respectively treated raw materials are comminuted to the final grain size, namely, with due regard to the target products to be obtained, for fine smoked sausage spread, coarse smoked sausage spread, onion sausage, Braunschweiger etc. Then, the filling into casings, cups or other suited envelopes is carried out.

If air-permeable casings are used, e.g. for smoked sausage spread or Braunschweiger, a smoking step may then be realized.

In one embodiment it is possible to retreat the finished products with high pressure so as to preclude any undesired influences caused by a possible recontamination after the first high-pressure treatment.

The advantage of the method described is not only the longer lasting spreadability of the finished product, but also the complete inactivation of microorganisms, with the pH-value remaining constant over a long period.

Incidentally, it is pointed out that, according to the teaching of the application, a difference is made between raw sausage and cooked sausage.

For raw sausage products the pH-value and the aw-value are to be reduced and a fermentation is to be carried out.

Cooked sausages obtain their product-specific properties primarily by a sufficient denaturation of the proteins.

According to another exemplary embodiment for the production of spreadable sausage having the product features of raw sausage, a raw material as lean as possible is salted, i.e. a raw material that contains no bacon.

Apart from nitrite curing salt also cooking salt may be used, as possibly present microorganisms are reliably inactivated by the subsequent high-pressure treatment.

If necessary, sugar is added for microorganisms to reduce the pH-value. Also, starter cultures or GDL may be added.

Of course, it is possible to add spices to the premixture or during the final comminution.

The raw material mixture is then coarsely pre-chopped and tempered afterwards, so that the reddening (only if nitrite curing salt is used) or the fermentation and acidification may take place during the storage.

If no water-absorbing substances are added to reduce the aw-value, the required drying takes place during the storage in appropriate rooms.

As the reddening, fermentation and pH-value reduction phase is exclusively carried out with lean raw meat material, the aw-value is higher as compared to the total mixture, which supports a faster maturation and pH-value reduction. Additionally, the higher starting water content of the raw materials facilitates the necessary drying.

The fermented and pH-value-reduced raw material is then subjected to a high-pressure treatment, with or without the addition of the pure fat portions, so as to obtain a coagulation of the protein and an inactivation of microorganisms.

This treatment results in a direct slight increase of the pH-value, which then remains constant over a longer period and coagulates the protein.

By means of these method steps the individual, mechanically separated pieces of meat remain separated during the subsequent production steps and the storage. Thus, the product remains spreadable for a very long time.

If the product to be filled at a later time is subjected to a second high-pressure treatment so as to inactivate microorganisms that find their way into the sausage meat during the production process (comminuting and filling), it is recommendable to add fat (bacon) only during the comminution to the final grain size.

The above-mentioned procedure has the advantage that the comminution of the fat is more uniform because the high-pressure treatment makes the fat more supple.

The recipe components comminuted to the final grain size are then filled into provided envelopes.

Even in a water-permeable casing the product remains spreadable for a long time. Air- and water-impermeable packagings, into which the comminuted material is filled, may be subjected to an additional supplementary high-pressure treatment so as to increase the product safety and shelf-life.

Spreadable or cuttable sausages or pies having the product features of cooked sausage are realized in accordance with the example described below.

The raw materials are coarsely pre-chopped and then mixed with salt—the use of cooking salt is possible as well—and spices.

If nitrite curing salt is used, an intermediate storage of the mixture is necessary to obtain a durable coloring, i.e. reddening.

If one raw material component is liver, the liver may be added to the total mixture. However, it is also possible to process the liver separately, possibly at slaughter temperature.

Usually, cooked sausage is produced from fatty and lean meat, with the addition of specific products, e.g. liver or blood.

Advantageously, the portions of lean meat are grown in.

The prepared raw materials are then subjected to a high-pressure treatment. The later consistency of the end product can be deliberately influenced by the intensity of and the exposure time to the high pressure.

By the possibility to adjust the pressure intensity and exposure time, it is possible to fulfill the most different requirements for the consistency of the respective end product, that is, from spreadable to cuttable.

The lower the pressure and the shorter the exposure times are chosen, the smaller is the degree of the desired protein denaturation.

A supplementary modification is the addition of liver, which may have slaughter temperature, or pretreated raw meat to the already pressure-pretreated raw materials during the final comminution process.

For reasons of food safety it is, in this case, required to subject the correspondingly filled final packages once more to a high-pressure treatment. Firm products may require the high-pressure treatment only after the final comminution and mixing phase.

As was stated in the introductory part of the specification the standard raw material preparation process for cooked sausage products requires the heating of the recipe components. During this heating meat protein, moisture and other ingredients, also vitamins, get lost.

To compensate the loss of moisture, a so-called broth is added during the final comminution. To avoid faulty products as a result of an excessive microbial load, another pasteurization of the end products according to the prior art, which is carried out subsequently, is common practice. The raw material treatment for cooked sausages by means of high pressure allows a production without the loss of vitamins, meat protein, spices, salt or moisture. An addition of external water is not necessary. Therefore, the production is environmentally friendly, and there is no need for the disposal of wastes which are difficult to degrade.

The filling process during the production of cooked sausage initially requires a comminution of the recipe mixture to the final grain size. The comminuted mixture is then filled into provided envelopes and once more treated with high pressure.

This additional high-pressure treatment prevents the separation of fat, which can often be found in the end product.

By using the above-described method the product remains spreadable substantially longer, even in a water-permeable casing, than had been possible before because of the known drying.

The production of spreadable raw sausage and similar spreadable products in accordance with the present invention is realized according to the exemplary embodiment described below.

In the following embodiment coarsely chopped raw materials used for the production of spreadable raw sausage need, surprisingly, not be subjected to a high-pressure treatment after the reduction of the pH-value and prior to the comminution because a protein denaturation occurs, which is caused by the acidification by means of starter cultures and/or protective cultures or so-called GDL. Thus, an undesired consolidation of lean meat portions after the comminution to the final grain size is prevented.

It is a prerequisite for this inventive embodiment that the proteins are denaturated completely and uniformly. After a treatment of this type the sausage meat comminuted to the final grain size can be filled into the provided envelope and treated by means of high pressure for the stabilization thereof, i.e. for the inactivation of microorganisms.

An appropriate choice of starter cultures and/or protective cultures may additionally have a specific influence on the degree of spreadability of the finished products.

The example described below proves that the pH-value of the spreadable sausages that were not subjected to a high-pressure treatment is further reduced, whereas the pH-value of the raw sausages that were treated with high pressure remains stable.

Incidentally, the high-pressure treatment renders the sensory perception of the acidification milder. That is, the teaching according to the invention permits the eschewal or reduction of nitrite curing salt, which is conventionally employed for coloring and the microbial protection of the semi-finished and finished products. Alternatively, the coloring may also be realized, for example, by adding beetroot.

The very quick acidification of the raw material mixture, the subsequent fast and reliable inactivation of microorganisms, and the coloring obtained by the addition of natural substances allow, in a surprising manner, the production of a raw sausage that fulfills all health-relevant conditions.

### Production of Smoked Spreadable Sausage HPP

### Guideline Index 2.212.1,

BEFFE (finely comminuted): not under 10%

### Recipe:

| Spices and ingredients, | | | +5 g/kg | | +5 g/kg | |
|---|---|---|---|---|---|---|
| meat material | Standard | | Guar gum | | Xanthan gum | |
| Starter cultures dehydrated | X | | X | | X | |
| Company Gewürzmüller | | | | | | |
| Dextrose | 5 | g/kg | 5 | g/kg | 5 | g/kg |
| Cooking salt (partially | 20 | g/kg | 20 | g/kg | 20 | g/kg |
| curing salt) | | | | | | |
| Beetroot | 0.5 | g/kg | 0.5 | g/kg | 0.5 | g/kg |
| Spice blend for smoked | 5 | g/kg | 5 | g/kg | 5 | g/kg |
| spreadable sausage | | | | | | |
| Beef I | 0.75 | kg | 0.75 | kg | 0.75 | kg |
| Pork II | 2.25 | kg | 2.25 | kg | 2.25 | kg |
| Pork VIII (fat) | 3 | kg | 3 | kg | 3 | kg |
| Total amount | 6.000 | kg | 6.000 | kg | 6.000 | kg |

### Production Method:

Coarsely mince and deep-freeze P VIII on the day before the production. Coarsely mince P II and B I also on the day before. Mix lean meat with the respective ingredients and spices+starter cultures. Let acidify to a pH-value of 5.2 to 5.4 at 15-18° C. in the climatic chamber. At the end, cool down in the climatic chamber. Mince meat to 3 mm, finely cut fat and meat, fill into casings and treat by means of HPP.

### Actual Production Procedure:

P VIII was coarsely minced and frozen on the day before the production. Moreover, P II and B I were coarsely minced and mixed in a kitchen aid with the respective ingredients, spices (salt proportionately) and rehydrated starter cultures. Dextrose was proportionately added to the dextrose contained in the spice. The single charges were placed in a climatic chamber for acidification to pH 5.2-5.4. A temperature of 15-18° C. was preset in the climatic chamber. As can be learned from the pH-value pattern the acidification of the mass (lean meat) started after about 8 hours. On the next day (12 February) the lean meat mass was acidified to a pH of about 5.2 (as shown).

Portions of the frozen, minced fat were cut finely, together with the acidified lean meat and the rest of the salt, and filled into an envelope. The filled smoked spreadable sausage was pressed for 3 minutes at 6000 bar.

On 11 February 1.5 kg of rehydrated starter cultures were added and mixed for 3 minutes.

### PH-Value Development of the Lean Meat:

| | | Guar | Xanthan |
|---|---|---|---|
| 1.5 g starter cultures per 3 kg | | gum | gum |
| lean meat | Standard | (0.5%) | (0.5%) |
| 02/11 8 a.m. (lean meat) | 5.7 | 5.75 | 5.73 |
| 02/11 4 p.m. (lean meat) | 5.55 | 5.62 | 5.62 |
| 02/12 7.30 a.m. (lean meat) | 5.47 | 5.21 | 5.23 |
| 02/12 10.30 a.m. (lean meat) | 5.21 | 5.18 | 5.23 |
| 02/15 8 a.m. (lean meat + fat/ | 5.52 | 5.53 | 5.57 |
| finished, high-pressure treated | | | |
| smoked spreadable sausage) | | | |
| 02/17 10 a.m. smoked spreadable | 5.51/5.21 | 5.52/5.19 | 5.53/5.22 |
| sausage pressed/not pressed | | | |

The production of firm pies or cooked sausages or products of a similar kind is carried out as follows.

If a relatively firm consistency is desired for cooked sausage products or pies, the ready-to-use raw material, salt and spice mixtures are comminuted to the final grain size without a prior high-pressure treatment. Subsequently, the reddened mass is filled into the envelopes provided therefor, which are then treated by means of high pressure for stabilization.

A test carried out to this effect is described below in tabular form and by means of the production method.

Production of a Liver Pâté by Means of a High-Pressure Treatment

### Recipe for Basic Firm Sausage Meat:

| Material | Portion in % | Portion in kg |
|---|---|---|
| Pork P II | 45 | 2.520 |
| Pork neck bacon PVI | 40 | 2.240 |
| Addition (ice) | 15 | [0.840] |
| Total | | 4.760 |

| | | |
|---|---|---|
| Spices and ingredients | amount per kg | amount for 4.760 kg |

| | | | | |
|---|---|---|---|---|
| Nitrite curing salt (NPS) | 20 | g | 95.2 | g |
| Ground white pepper | 2 | g | 9.5 | g |
| Mace | 1 | g | 4.8 | g |
| Ground ginger | 0.5 | g | 2.4 | g |
| Cardamom | 0.2 | g | 1 | g |

### Recipe for the Liver Mixture:

| | | |
|---|---|---|
| Material | Amount per kg | Amount absolute |

| | | | | |
|---|---|---|---|---|
| Pork liver, raw | | | 2.400 | kg |
| Nitrite curing salt (NPS) | 18 | g | 43.2 | g |
| Ground white pepper | 2 | g | 4.8 | g |
| Ground ginger | 0.5 | g | 1.2 | g |
| Cardamom | 0.3 | g | 0.7 | g |
| Mace | 0.5 | g | 1.2 | g |
| Onion granules | 5 | g | 12 | g |

### Manner of Preparation:

Cut P II and PVI to 3 mm, salt for 2 hours, and cut by using a conventional meat cutting method to obtain firm sausage meat.
Empty the meat cutter, and cut liver without salt and spices until it bubbles.
Add salt and spices, let run for some rounds, and cut in the firm sausage meat until the desired homogeneity is obtained.
Place the mass in the filler and fill into sterile casings.
High-pressure treatment of the sausages at 6000 bar and exposure time of 5 minutes.

### Result:

The high-pressure treated raw mixture for the liver pâté had a yellowish color. The structure was homogeneous, the consistency was surprisingly similar to that of a slightly more compact liver sausage, only thick slices could be cut off this product.

A clearly stronger solidification of the end product was surprisingly obtained by preheating the filled in raw sausage meat (>25° C.) and subjecting it in this state, in the likewise preheated pressure liquid, to a high-pressure treatment at about 6000 bar with an exposure time of about 3 minutes.

Apart from the increased consistency solidification the expected cooking flavor was observed.

Earlier tests have shown that apart from the raw material choice, the addition of vegetable additives (e.g. wheat fibers) can significantly increase the cutting firmness and the firmness to the bite of those products that were subjected to a high-pressure treatment only. Surprisingly, the consistency of products produced in this manner is comparable with the consistency of conventionally produced goods. A thermal pretreatment of the semi-finished product to improve the cutting firmness and the firmness to the bite can, therefore, be waived.

In connection with the production of salted cooked products, marinated meat products or similar products it could be demonstrated how the loss of color, which is significant in other cases, is reduced and how the degree of juiciness is increased, e.g. by increasing the pH-value.

The marinated turkey breast treated according to the inventive teaching resulted in the following values:

| | dripping loss in % |
|---|---|
| 600 MPa, raw | 35.0135014 |
| without pressure treatment, raw | 28.1265823 |
| 600 MPa, roasted | 17.25 |
| without pressure treatment, roasted | 28.2675439 |

In this example, the high-pressure treatment was applied at 6000 bar over a period of about 3 minutes. The meat pieces, which had a size of approximately 3×3 cm and a height of 1.5 cm, were roasted on both sides for about 1.5 minutes. The dripping losses were determined for 5 minutes, with a load of 5 kg and a weighed portion of about 1 g.

The test results obtained in tests with other meat varieties demonstrate that the high-pressure treatment surprisingly improves the water-binding properties, resulting in a greater juiciness of the finished foodstuffs. The higher water-binding properties make the product volume shrink to a smaller extent during the heat treatment, which, when meat thus treated is consumed, entails that the consumer perceives the high-pressure treated goods as more tenderly, as compared to the ordinary product produced without a high-pressure treatment.

The increased water-binding properties after a high-pressure treatment are surprisingly also obvious from the fact that unprotected cutting ends of liver sausage or also spreadable raw sausage desiccate to a significantly smaller degree during storage than goods produced according to the prior art.

Moreover, it has surprisingly been found in all high-pressure treated products that the salt intensity is perceived clearly stronger than in products produced according to the common production method. Tests have shown that the salt content in the recipes can be significantly reduced, i.e. by about 10%, which again serves the aspired tolerance of the products.

1. Method for controlling the product features during the production of foodstuffs attributable to the product groups raw sausage and cooked sausage, pies, cooked meat products or similar products, in particular to obtain spreading properties or cutting properties, according to Patent DE 10 2008 048 543,
characterized in that
for the production of raw sausage usual starting materials are salted, mixed and coarsely pre-chopped, not in a deep-frozen state, however, and this mixture is subjected to fermentation and acidification, i.e. pH-value reduction,
followed, after the protein denaturation, by a fine comminution or, alternatively, by a high-pressure treatment for the coagulation of the protein and inactivation of microorganisms, with the mechanically separated raw meat materials remaining separated.

2. Method according to claim 1,
characterized in that
a fine comminution is carried out after the high-pressure treatment step.

3. Method according to claim 1,
characterized in that
fat is added during the comminution to the final grain size, followed by a second high-pressure treatment.

4. Method for controlling the product features during the production of foodstuffs attributable to the product groups raw sausage and cooked sausage, pies, cooked meat products or similar products, in particular to obtain spreading properties or cutting properties, according to Patent DE 10 2008 048 543,
characterized in that
for the production of cooked sausage usual starting materials are salted, mixed and comminuted to final grain size in a non-heated state, while pies or firm products are coarsely pre-chopped, and this mixture is subjected to a high-pressure treatment in order to predefine the later consistency of the end product by means of the pressure intensity and the treatment time and the resulting degree of protein denaturation, wherein the recipe mixture comminuted to the final grain size is filled into a sales wrapping and subjected to a second high-pressure treatment, so that altogether fat separations in the product are prevented and the spreadability is preserved.

5. Method according to claim 4,
characterized in that
or the production of cooked sausage the product is filled into a water-permeable casing or water-permeable envelope.

6. Method according to claim 1,
characterized in that
a supplementary high-pressure treatment or a combined high-pressure treatment of the semi-finished product, the finished product, or of starting materials or taste-relevant additives, is carried out for the intensified perception of sensorially activated substances.

7. Method according to claim 6,
characterized in that
the salt portion in the product or mixture is reduced, depending on the implementation and intensity of the high-pressure treatment.

8. Method according to claim 2,
characterized in that
fat is added during the comminution to the final grain size, followed by a second high-pressure treatment.

9. Method according to claim 4,
characterized in that
a supplementary high-pressure treatment or a combined high-pressure treatment of the semi-finished product, the finished product, or of starting materials or taste-relevant additives, is carried out for the intensified perception of sensorially activated substances.
